(19) United States
(12) Patent Application Publication
(10) Pub. No.: US 2011/0084641 A1
(43) Pub. Date: Apr. 14, 2011

(54) APPARATUS AND METHOD FOR AUTOMATICALLY CONTROLLING WIPER OF VEHICLE

(75) Inventors: Doo-Seung UM, Seoul (KR); Sang-Hyeob KIM, Daejeon (KR); Myung-Ae CHUNG, Daejeon (KR)

(73) Assignee: Electronics and Telecommunications Research Institute, Daejeon-city (KR)

(21) Appl. No.: 12/888,018

(22) Filed: Sep. 22, 2010

(30) Foreign Application Priority Data
Oct. 12, 2009 (KR) 10-2009-0096829
Mar. 24, 2010 (KR) 10-2010-0026197

(51) Int. Cl. H02P 1/04; G01N 21/41

(52) U.S. Cl. 318/483; 356/128

(57) ABSTRACT

Provided is an apparatus and method for automatically controlling a wiper of a vehicle, the apparatus including a light emitting means to output one or more optical signals to an inside of a front glass of the vehicle, a light receiving means to receive the optical signals output from the light emitting means, and a control means to control the wiper of the vehicle to be driven based on a light receiving efficiency with respect to received signals received by the light receiving means, when operating in an automatic wiper control mode. Since driving of the wiper is automatically controlled based on the light receiving efficiency of optical signals output to the inside of the front glass, it is possible to secure a visual field of a driver without a need to separately manipulate manually a wiper controller.

### CROSS REFERENCE TO RELATED APPLICATIONS

This application claims priority to Korean Patent Application No. 10-2009-0096829 filed on Oct. 12, 2009 and Korean Patent Application No. 10-2010-0026197 filed on Mar. 24, 2010, the entire contents of which are herein incorporated by reference

### BACKGROUND OF THE INVENTION

1. Field of the Invention

The present invention relates to an apparatus and method for automatically controlling a wiper of a vehicle, and more particularly, to an apparatus and method for automatically controlling a wiper of a vehicle that may control a wiper drive of a vehicle and a driving speed of the wiper using a refractive index, a reflectivity, and a light receiving efficiency of optical signals output to an inside of a front glass of the vehicle.

2. Description of the Related Art

Currently, the automobile market is continuously expanding all over the world. In the US, a one car per person era is just around the corner. Korea is also on the verge with two cars per family-era beyond a one car per family era. In addition, since a capitalist system has accelerated in China and India, the automobile market is also globally growing.

Currently, the automobile market is one large scaled parts market, using various and parts. Accordingly, there are many automobile parts supplying companies.

The electronic parts are increasingly being used in the automobile market that used to be engineering industry, resulting in various types of sensors and electronic devices are being used for automobiles.

However, automobiles have become a necessity in lives of human beings, which still presents a danger to humans. At this time, research to develop many apparatuses for avoiding an accident caused by a human error is ongoing.

### SUMMARY OF THE INVENTION

An aspect of the present invention provides an apparatus and method for automatically controlling a wiper of a vehicle that may dispose a light emitting diode in an upper portion of a front glass of a vehicle and dispose a light receiving diode in a lower portion of the front glass, and may control a drive and a driving speed of a wiper based on a light receiving efficiency of optical signals received by the light receiving diode.

Another aspect of the present invention also provides an apparatus and method for automatically controlling a wiper of a vehicle that may verify a substance on a front glass of a vehicle by using a difference between a refractive index by an interface of glass/air and a refractive index by an interface of glass/water.

Another aspect of the present invention also provides an apparatus and method for automatically controlling a wiper of a vehicle that may adjust driving of a washing liquid injection nozzle and a washing liquid injection amount according to a type of a verified substance on a front glass of a vehicle.

According to an aspect of the present invention, there is provided an apparatus for automatically controlling a wiper of a vehicle, the apparatus including: a light emitting means to output one or more optical signals to an inside of a front glass of the vehicle; a light receiving means to receive the optical signals output from the light emitting means; and a control means to control the wiper of the vehicle to be driven based on a light receiving efficiency with respect to received signals received by the light receiving means, when operating in an automatic wiper control mode.

The control means may include: a calculator to calculate in real time a refractive index and a reflectivity of the optical signals with respect to the front glass of the vehicle based on a received angle of the received signals; and a decision unit to verify a substance on the front glass of the vehicle based on the refractive index and the reflectivity.

The calculator may calculate the refractive index and the reflectivity with respect to each of the optical signals of different wavelength regions.

The control means may further include a data processor to output a drive signal with respect to at least one of the wiper and a washing liquid injection nozzle according to a type of the verified substance by the decision unit, when the light receiving efficiency is less than a reference value.

When the type of the substance corresponds to water, the data processor may output a drive signal with respect to the wiper. The drive signal may include driving speed information associated with the wiper.

When the type of the substance does not correspond to water, the data processor may output a drive signal with respect to each of the wiper and the washing liquid injection nozzle. The drive signal may include driving speed information associated with the wiper and washing liquid injection amount information.

The control means may further include an optical signal controller to control an optical signal output of the light emitting means, and to measure the light receiving efficiency based on an amount of received light of the received signals.

The optical signal controller may measure the light receiving efficiency of the received signals with respect to each of optical signals of different wavelength regions.

The control means may further include a setting unit to determine a driving speed of the wiper and a washing liquid injection amount based on the light receiving efficiency.

The light emitting means may be disposed in an upper portion of the front glass of the vehicle based on a position of a driver's seat in the vehicle. The light receiving means may be disposed in a lower portion of the front glass of the vehicle based on the position of the driver's seat in the vehicle.

The light emitting means may include at least one light emitting diode to output an optical signal of an infrared ray region or a visible ray region.

According to another aspect of the present invention, there is provided a method of automatically controlling a wiper of a vehicle, the method including: outputting one or more optical signals to an inside of a front glass of the vehicle in a light emitting means; receiving the optical signals output from the light emitting means in a light receiving means; and controlling the wiper of the vehicle to be driven based on a light receiving efficiency with respect to received signals received by the light receiving means, when operating in an automatic wiper control mode.

The controlling may include calculating in real time a refractive index and a reflectivity of the optical signals with respect to the front glass of the vehicle based on a received angle of the received signals; and verifying a substance on the front glass of the vehicle based on the refractive index and the reflectivity.

The calculating may calculate the refractive index and the reflectivity with respect to each of the optical signals of different wavelength regions.

The controlling may further include: measuring the light receiving efficiency with respect to the received signals; and driving at least one of the wiper and a washing liquid injection nozzle according to a type of the verified substance, when the light receiving efficiency is less than a reference value.

The measuring may measure the light receiving efficiency of the received signals with respect to each of optical signals of different wavelength regions.

The driving may drive only the wiper, when the type of the substance corresponds to water.

The driving may drive both the wiper and the washing liquid injection nozzle when the type of the substance does not correspond to water.

The controlling may further include determining a driving speed of the wiper and a washing liquid injection amount based on the light receiving efficiency, prior to the driving.

The optical signals may be output from an upper portion to a lower portion of the front glass of the vehicle based on a position of a driver's seat in the vehicle.

According to embodiments of the present invention, since driving of a wiper of a vehicle is automatically controlled according to a light receiving efficiency of optical signals output to an inside of a front glass of the vehicle, it is possible to secure a visual field without a need to manipulate a wiper controller.

Also, according to embodiments of the present invention, since a substance on a front glass of a vehicle may be verified based on a refractive index and a reflectivity of an optical signal, it is possible to automatically control a washing liquid injection as well as driving of a wiper.

Also, according to embodiments of the present invention, unlike a known rain sensor, since it is possible to detect a state of a visual field of a driver, thus providing a stability. In addition, since the apparatus is inserted into an inside of a body of a vehicle, it is possible to improve the aesthetics of a vehicle.

### BRIEF DESCRIPTION OF THE DRAWINGS

FIG. 1 is a diagram illustrating a vehicle mounted with an apparatus for automatically controlling a wiper of a vehicle according to an embodiment of the present invention;

FIG. 2 is a diagram to describe a configuration of an apparatus for automatically controlling a wiper of a vehicle according to an embodiment of the present invention;

FIG. 3 is a block diagram to describe a configuration of an apparatus for automatically controlling a wiper of a vehicle according to an embodiment of the present invention;

FIGS. 4 and 5 are exemplary diagrams to describe an operation of an apparatus for automatically controlling a wiper of a vehicle according to an embodiment of the present invention; and

FIG. 6 is a flowchart illustrating a method of automatically controlling a wiper of a vehicle according to an embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, embodiments of the present invention will be described with reference to the accompanying drawings.

The present invention proposes an apparatus and method that may automatically control a wiper by applying a difference between a refractive index by an interface of glass/air and a refractive index of an interface of glass/water, and Snell's law.

Here, Snell's law is a theory that when waves are incident from an isotropic medium to another isotropic medium and thereby is refracted, a plane of incidence (a plane including a direction of incident waves and a normal line of a boundary plane) and a plane of refraction (a plane including a direction of refractive waves and a normal line of a boundary plane) exist within the same plane, and when an angle of incidence is i and an angle of refraction is r, a value of sin i/sin r, which is a ratio of an absolute refractive index of a medium, that is, a value of a relative refractive index, is constant at all times.

Accordingly, in the case of an optical signal passing through an inside of a front glass of a vehicle, a refractive index may vary depending on whether a substance attached onto an interface of glass is air or water (rainwater). Due to the difference of the refractive index, an amount of light in the inside of the glass may vary. The present invention relates to a control method of operating a wiper of the vehicle by determining whether an alien substance such as rainwater exists on the front glass 1 of the vehicle by detecting the above difference, and adjusting an operation speed of the wiper by detecting the above difference in real time.

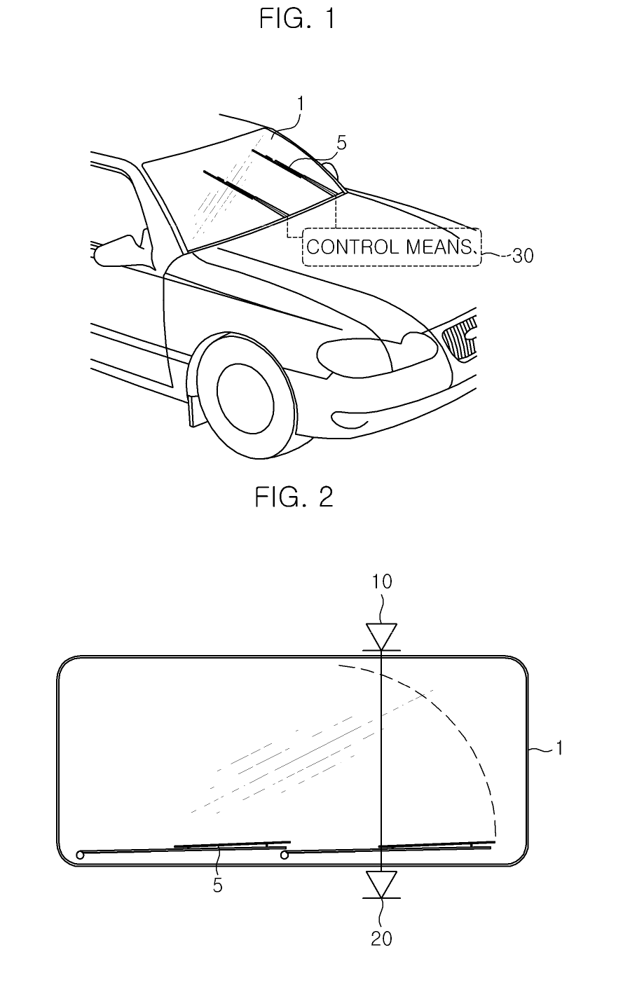

FIG. 1 is a perspective view of a vehicle mounted with an apparatus for automatically controlling a wiper 5 of a vehicle according to an embodiment of the present invention, and FIG. 2 is a front view of the front glass 1 of the vehicle of FIG. 1 and shows an example used to describe a configuration of an automatic wiper controlling apparatus of the vehicle according to an embodiment of the present invention.

As shown in FIG. 1, the wiper 5 is disposed on the front glass 1 of the vehicle mounted with the automatic wiper controlling apparatus according to an embodiment of the present invention. When driving the wiper 5, substances on the front glass 1 of the vehicle may be removed.

A control means 30 to automatically control driving of the wiper 5 may be disposed within the vehicle.

FIG. 2 is a front view of the front glass 1 of the vehicle of FIG. 1 and shows an example used to describe a configuration of the automatic wiper controlling apparatus of the vehicle according to an embodiment of the present invention.

In FIG. 2, a dotted line indicates a path of the wiper 5, and a solid line connecting a light emitting means 10 and a light receiving means 20 indicates a movement path of the optical signal.

As shown in FIG. 2, based on a position where a driver's seat is disposed in the vehicle, the light emitting means 10 is disposed in an upper portion of the front glass 1 of the vehicle and the light receiving means 20 is disposed in a lower portion of the front glass 1 of the vehicle.

Here, the light emitting means 10 may include at least one light emitting diode to output an optical signal of an infrared ray region or a visible ray region. In this instance, the light emitting means 10 and the light receiving means 20 may be vertically provided on a straight line. The light emitting means 10 may output an optical signal to an inside of the front glass 1 towards the light receiving means 20.

Also, the light receiving means 20 may include a photo detector to receive optical signals of various wavelength regions output from the light emitting means 10.

Since an optical signal output to the inside of the front glass 1 of the vehicle vertically moves based on the position of the driver's seat, the automatic wiper controlling apparatus of the present invention may measure a light receiving amount of the optical signal received via the light receiving means 20, and the like, to thereby verify a state of the front glass 1 of the vehicle and to secure a visual field for the driver.

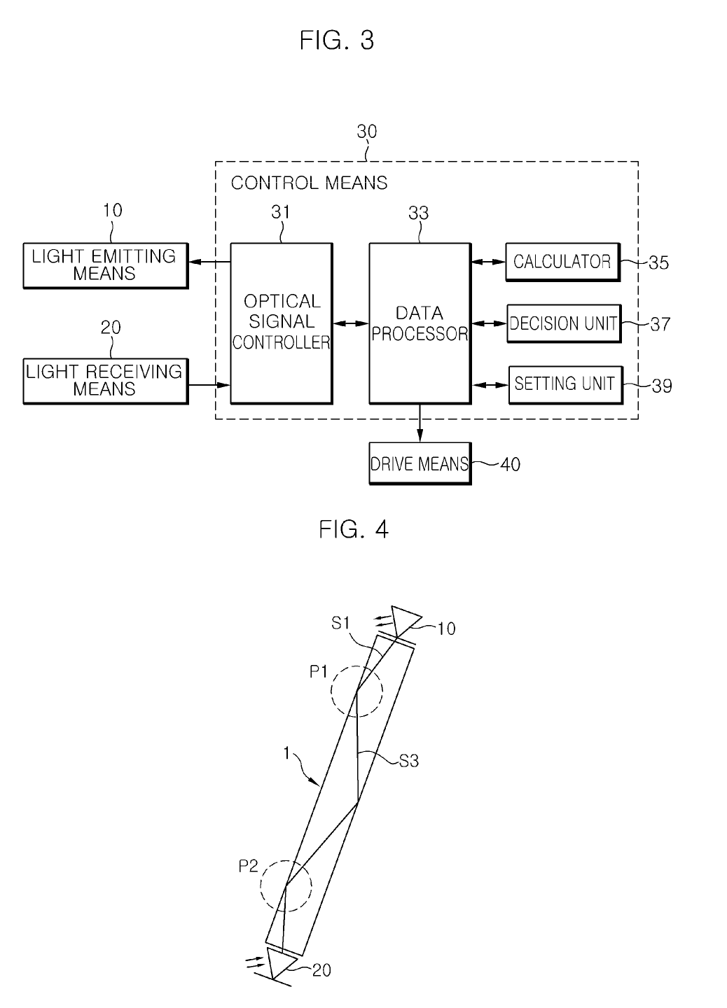

FIG. 3 is a block diagram to describe a configuration of an apparatus for automatically controlling a wiper of a vehicle according to an embodiment of the present invention.

As shown in FIG. 3, the automatic wiper controlling apparatus of the vehicle may include a light emitting means 10, a light receiving means 20, a control means 30, and a drive means 40.

The light emitting means 10 may output one or more optical signals to an inside of the front glass 1 of the vehicle. Also, the light receiving means 20 may receive the optical signals output from the light emitting means 10. Descriptions related to the light emitting means 10 and the light receiving means 20 are made above with reference to FIG. 2 and thus further description will be omitted here.

The control means 30 may control the wiper 5 of the vehicle to be driven based on a light receiving efficiency with respect to received signals received by the light receiving means 20, when operating in an automatic wiper control mode. Here, the control means 30 may include an optical signal controller 31, a data processor 33, a calculator 35, a decision unit 37, and a setting unit 39.

The optical signal controller 31 may control an optical signal output of the light emitting means 10. Also, the optical signal controller 31 may measure an amount of received light of the received signals received via the light receiving means 20, and may measure the light receiving efficiency based on the measured amount of received light. In this instance, since the received signals include optical signals of different wavelength regions, the optical signal controller 31 may measure the light receiving efficiency of received signals with respect to each of the optical signals of different wavelength regions.

The setting unit 39 may determine a driving speed of the wiper 5 and an injection amount of washing liquid based on the light receiving efficiency measured by the optical signal controller 31.

The calculator 35 may calculate in real time a refractive index and a reflectivity of optical signals with respect to the front glass 1 of the vehicle based on a received angle of received signals received by the light receiving means 20. In this instance, the calculator 35 may calculate the refractive index and the reflectivity with respect to each of the optical angles of the different wavelength regions.

Also, the decision unit 37 may verify a substance on the front glass 1 of the vehicle based on the refractive index and the reflectivity calculated by the calculator 35.

In this instance, the decision unit 37 may verify the substance on the front glass 1 of the vehicle using aspects that a refractive index of light varies depending on a substance and a critical angle of refraction varies in a contact portion between one substance and another substance.

Here, the critical angle may be calculated according to Snell's law when a refractive index of the substance is given. The above scheme is applied to an optical cable of an optical communication. It is possible to verify a state of vehicle glass by applying a phenomenon occurring within the optical cable to a glass window of the vehicle.

Specifically, since a refractive index of air on a day when it does not rain is different from a refractive index of air when it rains, a reflectivity between glass and air and a reflectivity between glass and rainwater correspondingly also vary. In this instance, the reflectivity difference is consequently connected to an intensity of light. Accordingly, the decision unit 37 may verify the state of the front glass 1 of the vehicle and the substance on the front glass 1 using a difference in the intensity of light.

To control the driving of the wiper 5, the data processor 33 may compare a reference value with the light receiving efficiency of received signals measured by the optical signal controller 31. When the light receiving efficiency of optical signals is less than the reference value, the data processor 33 may output a drive signal with respect to at least one of the wiper 5 and a washing liquid injection nozzle (not shown) according to the type of the substance on the front glass 1 verified by the decision unit 37.

When the type of the substance on the front glass 1 corresponds to water, the data processor 33 may output only a drive signal controlling the driving of the wiper 5. The output drive signal may include driving speed information associated with the wiper 5.

When the type of the substance on the front glass 1 does not correspond to water, the data processor 33 may output a drive signal with respect to each of the wiper 5 and the washing liquid injection nozzle. The output drive signal may include driving speed information associated with the wiper 5 and washing liquid injection amount information.

Accordingly, when it does not rain or when an alien substance such as dust barely exists on the front glass 1, the vehicle mounted with the automatic wiper controlling apparatus of the present invention may not operate the wiper 5. Conversely, when it rains or when it is difficult to secure a visual field due to the alien substance, the wiper 5 may be automatically operated together with injection of washing liquid. Also, in the case of the vehicle mounted with the automatic wiper controlling apparatus of the present invention, a speed of the wiper 5 may be automatically adjusted according to an amount of rain and thus a driver may have no need to manipulate a wiper controller for securing the visual field every time.

When not operating in the automatic wiper control mode, the control means 30 may control driving of the wiper 5 and the washing liquid injection nozzle according to a manual control of the existing wiper controller and the like.

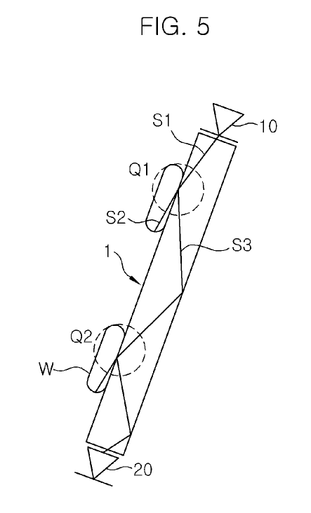

FIGS. 4 and 5 are exemplary diagrams to describe an operation of an apparatus for automatically controlling a wiper of a vehicle according to an embodiment of the present invention.

When passing through a transparent and hard plane such as glass, an internal reflection may occur a plurality of times during the passing process. A partial reflection and a total reflection may occur depending on an incident angle of light. Also, a critical angle may vary depending on a physical boundary condition. When using the above property, whether a front glass 1 portion of the vehicle contacts with air or contacts with rainwater, or contacts with dusts may be determined.

Specifically, the decision unit 37 may determine that an alien substance is stained on the glass based on a light absorption rate of the light receiving means 20 using a property of a total reflection phenomenon occurring when glass contacts with air, and of the partial reflection occurring when rainwater is splashed on the glass, by referring to figures with respect to the total reflection and the partial reflection according to a property of a physical boundary plane.

For example, since a refractive index N_{g} of glass is about 1.5, a refractive index Nₐ of air is about 1.00029, and a refractive index N_{w} of water is about 1.333, a ratio of N_{g}/Nₐ becomes greater than a ratio of N_{g}/N_{w}, whereby a critical angle in the boundary plane between glass and water increases.

Accordingly, even though the total reflection phenomenon occurs in the boundary plane between glass and air, the critical angle may increase when rainwater drops on the glass, whereby the partial reflection phenomenon occurs, which may result in decreasing the intensity of light at the light receiving means 20. In this instance, the decision unit 37 may determine the existence of rainwater on the front glass 1 based on the intensity of light measured by the light receiving means 20, and thereby operate the wiper 5.

Here, FIG. 4 shows an example of a total reflection of an optical signal output to an inside of glass when the front glass 1 of the vehicle contacts with air. As shown in FIG. 4, the optical signal output from a light emitting element disposed in an upper portion of the front glass 1 may arrive at the light receiving means 20 disposed in a lower portion of the front glass 1 while performing total reflection along glass within the inside of the front glass 1 of the vehicle.

In this instance, the optical signal may be total reflected at points P1 and P2 on the front glass 1. Accordingly, an original signal S1 and a refracted signal S3 may have the same signal strength.

Similarly, since the above operation may also occur at a point P2, received signals received by the light receiving means 20 may have the same signal strength as optical signals output from the light emitting means 10. Consequently, it is possible to achieve a high light receiving efficiency.

FIG. 5 shows an example of a partial reflection of an optical signal output to an inside of glass when the front glass 1 of the vehicle contacts with rainwater. As shown in FIG. 5, the optical signal is partially reflected at points Q1 and Q2 on the front glass 1.

Specifically, at the point Q1, a reflected signal S2 of an original signal S1 is reflected to an inside of the rainwater, and a remaining reflected signal S3 is refracted to an inside of the front glass 1. Accordingly, the original signal S1 and the refracted signal S3 may have a different signal strength, which is different from FIG. 4. In this instance, S3 may have a lower signal strength than S1.

Similarly, since the above operation may also occur at the point Q2, received signals received by the light receiving means 20 may have a relatively low signal strength compared to optical signals output from the light emitting means 10. Consequently, a low light receiving efficiency may be obtained.

Based on the results of FIGS. 4 and 5, the decision unit 37 may verify a state of glass and the data processor 33 may determine whether to operate the wiper 5.

In this instance, a difference of a total reflection rate may increase according to an amount of rainwater. The setting unit 39 may determine the difference to thereby determine a driving speed of the wiper 5.

Also, even when an alien substance such as dust is attached onto the front glass 1 of the vehicle, the total reflection rate may vary and thus the setting unit 39 may determine the varying total reflection rate to thereby determine a washing liquid injection amount. The data processor 33 may drive the washing liquid injection nozzle and may also simultaneously enable the wiper 5 to wipe off the front glass 1, thereby making it possible to secure a visual field of a driver.

Hereinafter, an operation of the present invention constructed as above will be described.

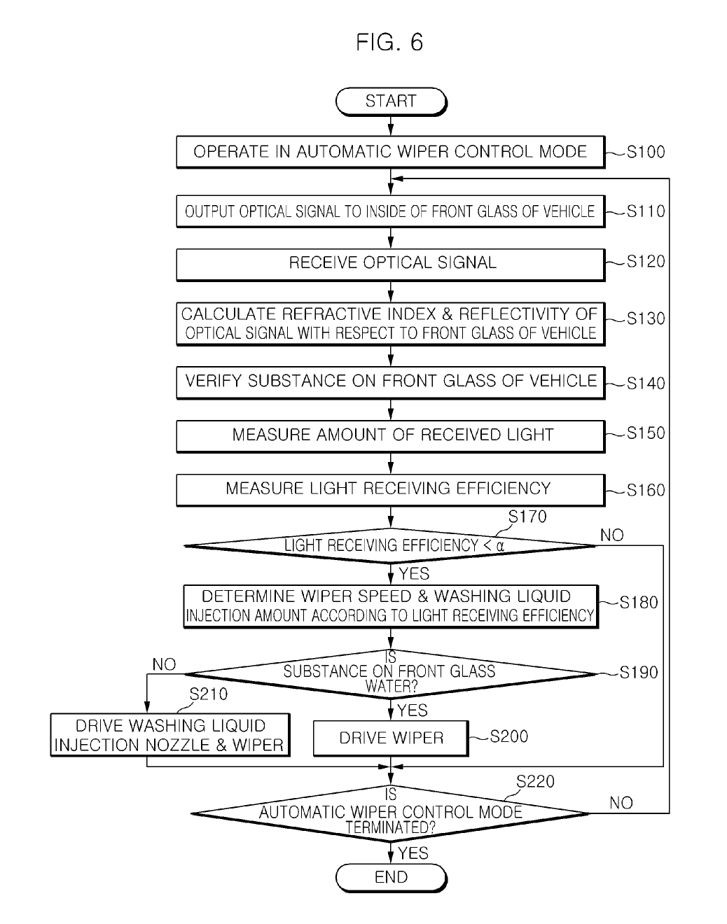

FIG. 6 is a flowchart illustrating a method of automatically controlling a wiper of a vehicle according to an embodiment of the present invention.

As shown in FIG. 6, when operating in an automatic wiper control mode (S100), the optical signal controller 31 may control an optical signal output of the light emitting means 10. Accordingly, the light emitting means 10 may output one or more optical signals to an inside of the front glass 1 of the vehicle (S110) and the light receiving means 20 may receive the optical signals output from the light emitting means 10 (S120).

The calculator 35 may calculate in real time a refractive index and a reflectivity of optical signals with respect to the front glass 1 of the vehicle based on a received angle of received signals received by the light receiving means 20 (S130). Also, the decision unit 37 may verify a substance on the front glass 1 of the vehicle based on the refractive index and the reflectivity calculated by the calculator 35 (S140).

The optical signal controller 31 may measure an amount of received light of received signals received via the light receiving means 20 (S150), and may measure a light receiving efficiency based on the measured amount of received light (S160).

In this instance, to control driving of the wiper 5, the data processor 33 may compare a reference value with the light receiving efficiency of received signals measured by the optical signal controller 31 (S170). When the light receiving efficiency is determined to be less than the reference value in step ‘S170’, the setting unit 39 may determine a driving speed of the wiper 5, an injection amount of washing liquid, and the like according to the light receiving efficiency measured by the optical signal controller 31 (S180).

Also, the data processor 33 may output a drive signal with respect to at least one of the wiper 5 and a washing liquid injection nozzle according to the type of the substance on the front glass 1 verified in step ‘S140’.

When the type of the substance on the front glass 1 corresponds to water (S190), the data processor 33 may output only a drive signal controlling the driving of the wiper 5 (S200). In this instance, the output drive signal may include driving speed information associated with the wiper 5.

When the type of the substance on the front glass 1 does not correspond to water (S190), the data processor 33 may output a drive signal with respect to each of the wiper 5 and the washing liquid injection nozzle (S210). In this instance, the output drive signal may include driving speed information associated with the wiper 5 and washing liquid injection amount information.

Here, steps ‘S110’ to ‘S210’ may be repeatedly performed until the automatic wiper control mode is terminated (S220).

Although an embodiment of FIG. 6 illustrates a process of automatically controlling a wiper and a washing liquid injection nozzle when operating in an automatic wiper control mode, any one of the wiper and the washing liquid injection nozzle may be manually controlled according to an initial setting.

That is, when the washing liquid injection nozzle is set to be manually manipulated, only the drive signal with respect to the wiper may be output in step ‘S210’.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for automatically controlling a wiper of a vehicle, the apparatus comprising:
a light emitting means to output one or more optical signals to an inside of a front glass of the vehicle;
a light receiving means to receive the optical signals output from the light emitting means; and
a control means to control the wiper of the vehicle to be driven based on a light receiving efficiency with respect to received signals received by the light receiving means, when operating in an automatic wiper control mode.

2. The apparatus according to claim 1, wherein the control means includes:
a calculator to calculate in real time a refractive index and a reflectivity of the optical signals with respect to the front glass of the vehicle based on a received angle of the received signals; and
a decision unit to verify a substance on the front glass of the vehicle based on the refractive index and the reflectivity.

3. The apparatus according to claim 2, wherein the calculator calculates the refractive index and the reflectivity with respect to each of the optical signals of different wavelength regions.

4. The apparatus according to claim 2, wherein the control means further includes:
a data processor to output a drive signal with respect to at least one of the wiper and a washing liquid injection nozzle according to a type of the verified substance, when the light receiving efficiency is less than a reference value.

5. The apparatus according to claim 4, wherein:
when the type of the substance corresponds to water, the data processor outputs a drive signal with respect to the wiper, and
the drive signal comprises driving speed information associated with the wiper.

6. The apparatus according to claim 4, wherein:
when the type of the substance does not correspond to water, the data processor outputs a drive signal with respect to each of the wiper and the washing liquid injection nozzle, and
the drive signal comprises driving speed information associated with the wiper and washing liquid injection amount information.

7. The apparatus according to claim 1, wherein the control means further includes:
an optical signal controller to control an optical signal output of the light emitting means, and to measure the light receiving efficiency based on an amount of received light of the received signals.

8. The apparatus according to claim 7, wherein the optical signal controller measures the light receiving efficiency of the received signals with respect to each of optical signals of different wavelength regions.

9. The apparatus according to claim 1, wherein the control means further includes:
a setting unit to determine a driving speed of the wiper and a washing liquid injection amount based on the light receiving efficiency.

10. The apparatus according to claim 1, wherein:
the light emitting means is disposed in an upper portion of the front glass of the vehicle based on a position of a driver's seat in the vehicle, and
the light receiving means is disposed in a lower portion of the front glass of the vehicle based on the position of the driver's seat in the vehicle.

11. The apparatus according to claim 1, wherein the light emitting means includes at least one light emitting diode to output an optical signal of an infrared ray region or a visible ray region.

12. A method of automatically controlling a wiper of a vehicle, the method comprising:
outputting one or more optical signals to an inside of a front glass of the vehicle;
receiving the optical signals output from the light emitting means; and
controlling the wiper of the vehicle to be driven based on a light receiving efficiency with respect to received signals received by the light receiving means, when operating in an automatic wiper control mode.

13. The method according to claim 12, wherein the controlling includes:
calculating in real time a refractive index and a reflectivity of the optical signals with respect to the front glass of the vehicle based on a received angle of the received signals; and
verifying a substance on the front glass of the vehicle based on the refractive index and the reflectivity.

14. The method according to claim 13, wherein the calculating calculates the refractive index and the reflectivity with respect to each of the optical signals of different wavelength regions.

15. The method according to claim 13, wherein the controlling further includes:
measuring the light receiving efficiency with respect to the received signals; and
driving at least one of the wiper and a washing liquid injection nozzle according to a type of the verified substance, when the light receiving efficiency is less than a reference value.

16. The method according to claim 15, wherein the measuring measures the light receiving efficiency of the received signals with respect to each of optical signals of different wavelength regions.

17. The method according to claim 15, wherein the driving drives only the wiper, when the type of the substance corresponds to water.

18. The method according to claim 15, wherein the driving drives both the wiper and the washing liquid injection nozzle, when the type of the substance does not correspond to water.

19. The method according to claim 12, wherein the controlling further includes:
determining a driving speed of the wiper and a washing liquid injection amount based on the light receiving efficiency, prior to the driving.

20. The method according to claim 12, wherein the optical signals are output from an upper portion to a lower portion of the front glass of the vehicle based on a position of a driver's seat in the vehicle.
